(19) United States
(12) Patent Application Publication
(10) Pub. No.: US 2010/0029305 A1
(43) Pub. Date: Feb. 4, 2010

(54) SMS AND VOICE MESSAGING TO GPS

(75) Inventor: SHEKHAR GUPTA, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/182,279

(22) Filed: Jul. 30, 2008

(51) Int. Cl. H04Q 7/20; G01S 1/00

(52) U.S. Cl. 455/466; 342/357.1

(57) ABSTRACT

A Global Positioning System (GPS) device and method for communicating data from a telecommunications device to a GPS device includes establishing a communications link between a telecommunications device and a GPS device. Message data may be received from the telecommunications device by the GPS device via the communications link. Message data may be displayed by the GPS device. GPS input data may be selected from the displayed message data. Directions may be calculated based on the selected GPS input data.

### BACKGROUND OF THE INVENTION

Modern uses for cellular or mobile telephones go far beyond placing and receiving telephone calls. In addition to placing calls, cellular phones are capable of browsing websites, sending text messages, playing music or video, among a host of other functions. Many cellular telephones now have Global Positioning System (GPS) technology capability as well. Working with a remote service provider, the GPS functionality on a phone can provide the remote service provider with data necessary to receive directions in real-time, similar to the directions given on a stand-alone GPS device.

A common option on vehicles today are navigation systems, which also use GPS technology. Navigation systems, sometimes referred to as GPS systems or devices, commonly have an electronic display built into a vehicle. Rather than being permanently attached, some navigation systems are portable devices that are removable from the vehicle. GPS systems can be used to display the current location of the vehicle as well as provide directions to addresses or other landmarks entered into the navigation system. Along with the current location and route directions, GPS systems are capable of determining speed and direction being traveled by the vehicle and most have a variety of other capabilities.

Navigation systems, particularly built-in ones, may be integrated with other systems in the car. Currently, cellular phones may be registered with in-vehicle navigation systems. One way of registering a cellular phone with a navigation system is using Bluetooth®, a commonly known wireless communications protocol. When a call comes in for a registered cellular phone, the navigation system's screen or other electronic display in the vehicle may display the caller's name or telephone number, similar to caller ID. Functionality between the cellular phone and navigation system is currently limited to displaying caller ID and cellular phone contact information, as well as the ability to transfer voice and audio between the cellular telephone and the navigation system.

### SUMMARY OF THE INVENTION

In order to more efficiently input address data into a GPS system, as well as provide greater functionality to users of a GPS system, message data may be communicated from a telecommunications device to a GPS system, where relevant location data may be automatically, semi-automatically, or manually selected. Message data may be from voice communications, such as a voicemail message, or may be in text format, such as a short message service (SMS) message. Analyzing the messages to locate potential addresses, and other potential GPS input data, allows the GPS device to pre-populate fields for entry of an address in which a user would like to be routed.

One embodiment of a method for communicating data from a telecommunications device to a GPS device includes establishing a communications link between a telecommunications device and a GPS device. Message data may be received from the telecommunications device by the GPS device via the communications link. The message data may be displayed by the GPS device. GPS input may be selected from the displayed message data. Directions may be calculated based on the selected GPS input.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary environment for communicating message data from a telecommunications device to a GPS device;

FIG. 2A is an illustration of an exemplary screen shot depicting a message list on a GPS electronic display;

FIG. 2B is an illustration of an exemplary screen shot depicting message analysis and address selection according to principles of the present invention;

FIG. 2C is an illustration of an exemplary screen shot for updating address fields according to principles of the present invention;

FIG. 2D depicts a screen shot of an exemplary keyboard for use in entering text into a data entry field;

FIG. 3 is a block diagram of exemplary components of a GPS device configured to facilitate communication of message data from a telecommunications device;

FIG. 4 is a block diagram of exemplary software modules for a GPS device according to principles of the present invention; and

FIG. 5 is a flow chart of an exemplary process for communicating message data from a telecommunications device to a GPS device.

### DETAILED DESCRIPTION OF THE DRAWINGS

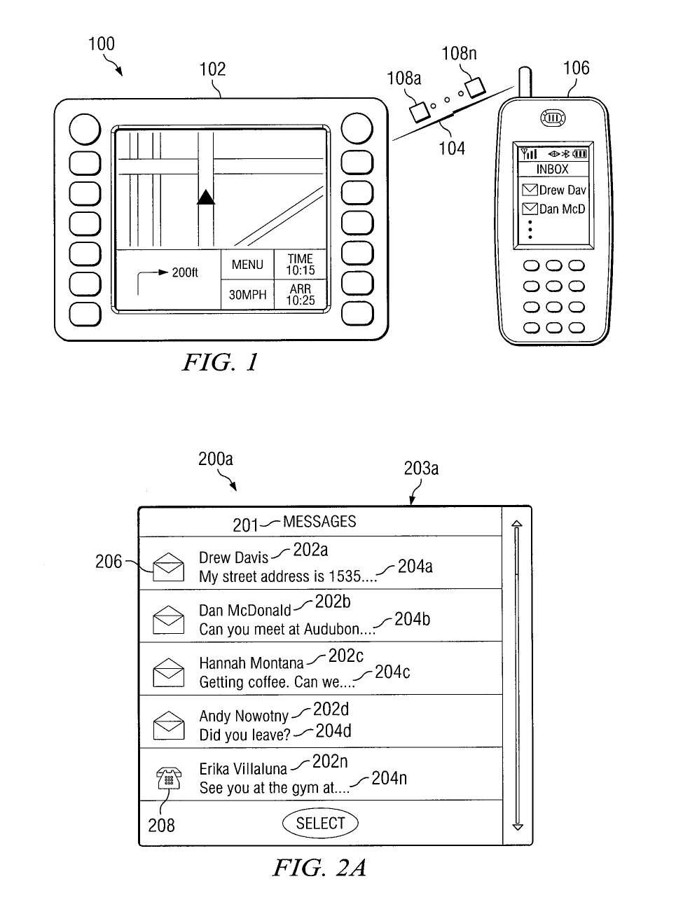

FIG. 1 is an illustration of an exemplary environment 100 for communicating message data from a telecommunications device to a GPS device. A GPS device 102 may communicate, via a local communications link 104, message data in the form of data packets 108a-108n (collectively 108) to a telecommunications device 106. The GPS device 102 may be permanently attached to a vehicle, such an in-vehicle navigation system, or may be a portable device that can be removed from the vehicle and used in other locations. The local communications link 104 may connect the devices 102 and 106 wirelessly using Bluetooth® communications protocol, as is well known in the art. Any other wireless communications protocol capable of communicating message data between the devices 102 and 106 may also be used. Alternatively, in the event that a wired connection may be made between the devices, (e.g. a docking port, USB port, or line-in capability), the data may be communicated over various wired communications protocols as is commonly known in the art.

The data packets 108 may contain audio or text data and may be bi-directional for communicating requests or input from the GPS device 102 as well as content, such as voice or text message data, from the telecommunications device 106. In an exemplary embodiment, bi-directional voice for calls currently taking place, voice from voicemail messages received by the telecommunications device, SMS messages, contact lists stored on the telecommunications device, commands for requesting message data from the telecommunications device, as well as other types of data may be communicated within the data packets 108.

In addition to sending voice or text message data from the telecommunications device 106 to the GPS device 102, in one embodiment, the bidirectional communication may also provide the capability for SMS messages generated using the GPS device 102 to be communicated to the telecommunications device 106 for delivery to an end user. Any input method that is accessible to the GPS device 106 may be used. Common input methods may include a keyboard or virtual keyboard on the GPS device 102, speech, using speech-to-text conversion, or any other input method in which the GPS device 102 is capable of utilizing. Having the capability to input an SMS message using the GPS device 102 allows a user to more conveniently send an SMS message, and in the case where audio is used for the input, this method allows for hands-free text messaging by utilizing a modified version of a voice command interface already contained in the GPS device 102.

The telecommunications device 106 may be any type of telecommunications device, such as a cellular telephone, PDA, pager, or any other type of telecommunications device capable of communicating data messages. The telecommunications device may be a portable cellular telephone that is removable from a vehicle, or may be a fixed telecommunications device that is installed within the vehicle. It is intended that any combination of fixed or removable telecommunications devices and GPS devices may be used. Additionally, more than one telecommunications device (not shown) may be in communication with the GPS device at any given time.

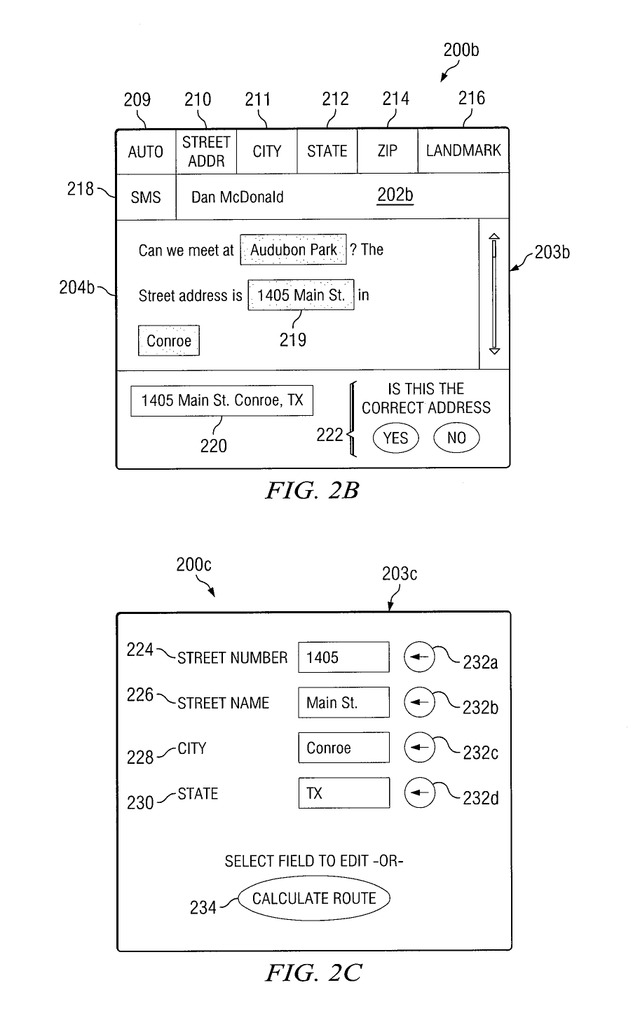

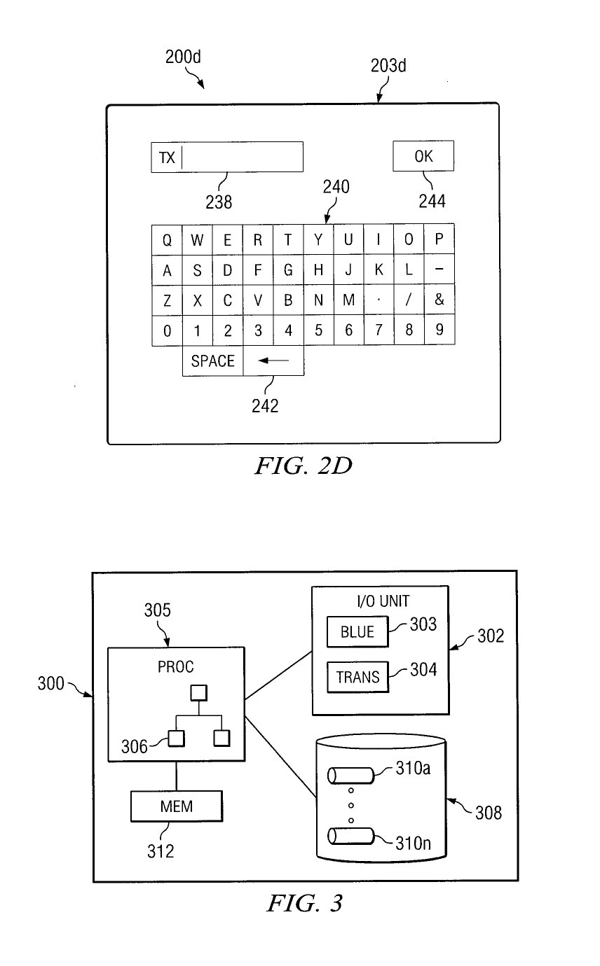

FIG. 2A is an illustration of an exemplary screen shot 200a depicting a message list 201 on a GPS electronic display 203a. In one embodiment, the message list 201 includes a sender name 202a-202n (collectively 202) and associated message text 204a-204n (collectively 204). In addition, an indication of the type of content, such as a envelope icon 206 for text messages and a telephone icon 208 for a voice message, may be provided for each message. Additional indications of content may also be provided that correspond to other types of message content that is delivered to the GPS device.

The message list 201 may be displayed on the GPS electronic display 203a in place of a map or input menu that would typically be shown. Alternatively, the message list 201 may take up only a part of the GPS electronic display 203a, allowing the map and message list 201 to be displayed simultaneously. The message list 201 may display all or part of each sender's name 202 or message 204 depending upon the length of the sender's names 202 and messages 204 as well as the size of the GPS electronic display 203a. From the message list 201, a user may select the message to be viewed. Input may take place by using touch screen input, audio commands (i.e. voice commands), local or remote buttons, or any other input method that the GPS device is capable of accepting.

FIG. 2B is an illustration of an exemplary screen shot 200b depicting message analysis and address selection according to principles of the present invention. Selecting a message from the message list 201 (FIG. 2A) may cause a new screen, such as shown in screen shot 200b, to be displayed on the GPS electronic display 203b. Various selectable icons may be displayed on the GPS electronic display 203b, such as “AUTO” 209, “STREET ADDR” 210, “CITY” 211, “STATE” 212, “ZIP” 214 and “LANDMARK” 216, and be selectable icons to assist a user in the selection of an address. An origination indication 218 may be provided to indicate whether the message was originally an SMS message, voice message, or any other type of message capable of being displayed on the GPS electronic display 203b. The origination indication 218 may be text or graphics. A sender field 202b may display the sender of the selected message. In this example, the second message from screen shot 200a (FIG. 2A) is selected, which is a message from “DAN MCDONALD.”

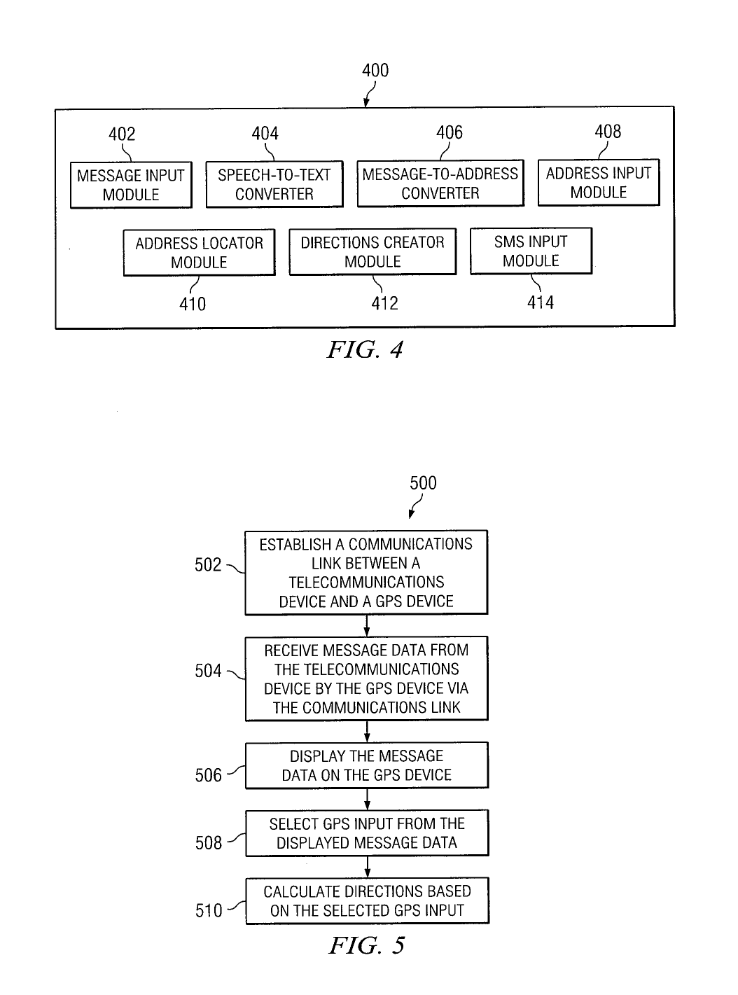

In an exemplary embodiment, a message selected from the message list 201 (FIG. 2A) may be displayed in screen shot 200b. The displayed message 204b may show portions of text of the displayed message 204b highlighted based on an analysis of the message. The highlighted text may be recognized as potential GPS input data, such as address details or landmark information. More detail on the message analysis will be described below in regards to FIG. 4. The highlighted text may be selected by any input selection method, such as touch screen, MMI, mouse, stylus, audio or voice commands, or any other input method that the GPS device is capable of accepting. The selected highlighted text may then be associated with address fields automatically, semi-automatically, or manually by selecting one of the afore-mentioned icons 209-216. For example, “1405 Main St.” may be highlighted based on automatic analysis of the message in response to a user selecting “AUTO” icon 209. A user may select a text containing “1405 Main St.” to form a highlighted text box 219 then select “STREET ADDR” icon 210. Selecting text followed by “STREET ADDR” icon 210 associates highlighted text box 219 with the street address field used for calculating directions. Alternatively, the selectable icons 209-216 may be selected first, followed by the text the user would like to have associated with the field, with the same result.

The selectable icons 209-216 may be used to “map” text of the messages into fields of an address. “AUTO” icon 209 may be selected to have the GPS device automatically “map” message text determined to be related to an address into fields that may be used to calculate directions by the GPS system. Automatic mapping may occur as a default action to displaying the message or may be selected manually. In addition to “STREET ADDR” icon 210 as described above, the user may select for “CITY” icon 211, “STATE” icon 212, and “ZIP” icon 214 for specifying that text in the message 204b is the city, state, and ZIP code, respectively, of the destination. The selectable icon 216 labeled “LANDMARK” may be used for well known landmarks that may be known by the GPS device. For example, “Audubon Park” text from the displayed message 204b may be a known landmark and may be associated with an address by the GPS device without further information being necessary.

An address field 220 may be displayed that presents to the user of the GPS device a suggested address. The suggested address may be correct, partial, or incorrect, but is an address that is generated using information available in the message 204b. Answer buttons 222, allow the user to inform the GPS device as to whether or not the generated address is accurate. In some situations, the full information may not be located within the text of the message and additional user intervention may be needed.

In one embodiment, upon selecting the answer button 222 displaying “NO” (i.e., indicating that the suggested address is not the correct address), an additional screen may be displayed. FIG. 2C is an illustration of an exemplary screen shot 200c of a GPS electronic display 203c for updating one or more address fields according to principles of the present invention, and allows the user to input a correct address by editing specific fields that have been incorrectly pre-populated or lack data. The fields may include “STREET NUMBER” 224, “STREET NAME” 226, “CITY” 228, and “STATE” 230. The specific field to be edited may be selected using a number of methods. One method is by selecting an icon, such as select arrows 232a-232d (collectively 232). When the select arrow 232 is selected, a keyboard (FIG. 2D) may be displayed enabling the user to input correct information for the field. If the information shown is determined to be the information desired by the user, the “CALCULATE ROUTE” button 234 may be selected. The directions may be calculated at this point as directions are normally calculated using traditional GPS devices, which is well known in the art.

FIG. 2D depicts a screen shot 200d showing a GPS electronic display 203d with an exemplary keyboard 240 for use in entering text into a selected field. An input box 238 may be displayed showing content that is currently in the selected field. In this example, the state field 230 from FIG. 2C was selected. As shown, the text “TX” is displayed, which indicates the State of Texas. If the field representing the state should contain “GA” rather than “TX,” a user may backspace over content in the input box using the backspace key 242 and the type “GA” from the keyboard 240. Upon entry of the correct information, an “OK” button 244 may be selected. The previous screen may then be displayed allowing the user to select other fields 224-228 to be edited or the “CALCULATE ROUTE” button 234 may be selected. Any number of variations of keyboards may be used. Alternatively, audio commands or any other input methods that the GPS device is capable of accepting may be utilized.

FIG. 3 is a block diagram of exemplary components of a GPS device 300 configured to facilitate reception of message data from a telecommunications device. The GPS device 300 may include an input/output (I/O) unit 302 for receiving message data from a telecommunications device. The I/O unit 302 may additionally include a Bluetooth® device for enabling communication between the GPS device 300 and the telecommunications device, and a transceiver 304 for transmitting and receiving coordinates and other information with GPS satellites.

The GPS device 300 may also include a processor 305 for processing GPS navigation information and message content from the telecommunications device. The processor 305 may execute software 306 capable of performing the functionality of the GPS device 300 as provided by the principle of the present invention. Software modules that operate in the software 306 are described below in more detail in reference to FIG. 4. A storage unit 308 may also be included in, or be in communication with, the GPS device 300. The storage unit 308 may be a hard drive or any other type of volatile or non-volatile memory capable of storing data. Within the storage unit 308 may be one or more data repositories 310a-310n, such as a database or multiple databases, capable of storing and organizing data, such as addresses or GPS coordinates. In one embodiment, rather than including the storage unit 308, the GPS device 300 may use a memory 312 that is large enough to store data for use in providing address insertion functionality as described herein. Memory 312 may also be located within the GPS device 300 for storing data being processed by the processor 305.

FIG. 4 is a block diagram of exemplary software modules 400 for a GPS device according to principles of the present invention. The software modules 400 may include software used in a traditional GPS device as well as additional modules for enabling integration of message data received from a telecommunications device with the address insertion functionality on the GPS device.

A message input module 402 may allow for the communication of message data from a telecommunications device to a GPS device. As described previously, the message data may be in an audio format, such as a voicemail message, or in text based format, such as an e-mail or SMS message. However, any other type of message data capable of being converted to text and displayed through the GPS device may be used. Software facilitating the communication, such as Bluetooth® technology software, or other software for alternative communications protocols capable of transmitting message data between the GPS device and the telecommunications device, may be used.

For audio messages that are received by the message input module 402, a speech-to-text converter module 404 may be used to allow the GPS device to process the audio messages. Voicemail, for example, may be converted into text using the speech-to-text converter module 404, where the converted speech may then be used to generate potential address information from the messages. Other potential GPS input, besides address information, may also be generated. For example, landmarks that may be known to the GPS device may be recognized during message processing. The speech-to-text converter module 404 may not always be used for every message, as the speech-to-text converter module would not be necessary when message data includes only text-based information.

Additionally, the speech-to-text converter module 404 may be the same module or a similar module to the one that would allow for audio commands to control the GPS device. While audio commands may be communicated to the GPS device using a microphone to control the GPS device, the message data in audio format may be input into the GPS device using Bluetooth® or another type of communication protocol. Despite any differences that may exist between input methods, the same speech-to-text conversion module 404 may be used for both functionalities. Alternatively, separate modules may be used.

A message-to-address converter module 406 may operate to analyze message data that is received by the GPS device in order to locate information within the message data that may be associated with a physical location. For example, by locating cues or keywords within the text that are typically associated with physical locations or addresses, the message-to-address converter module 406 may select surrounding text from the message to pre-populate an address input box. In some cases, the message data provides enough detail that the message-to-address converter module 406 is able to generate an accurate address. However, in other cases, the message may not give sufficient detail.

An address input module 408 may be called by the message-to-address converter module 406 in order to modify any information that is incorrectly associated with an address field or to provide additional address field information that was not located within the message. As described previously in regard to FIGS. 2C and 2D, a keyboard screen or other input device or method may be provided to interface with the address input module 408. Particular address fields may be selected and the data modified. Alternatively, the entire address may modified at one time, depending upon the particular input screen being used. For traditional use of a GPS device without address information being located within message data, the address input module 408 may alternatively be called at any time to input an address as is customarily provided for by GPS device.

An address locator module 410 may accept the address as entered through the various modules previously described and determine the coordinates of a particular destination address that is desired. The address locator module 410 may be the same or similar to address locator modules used in a traditional GPS device in that a database of addresses corresponding to coordinates may be searched to determine if the address that has been entered is found within the database. Upon determining that a location is within the database, the coordinates may be sent to the directions creator module 412 for the directions to be calculated for the route. If the address is not within the database of known addresses, an option to select another address or to enter in another address may be offered to the user.

Based on the information gathered by the other modules, the directions creator module 412 may be used to determine directions to the address that has been entered into the GPS system. The directions creator module 412 may function the same or similar to a traditional GPS system. Using the current coordinates and the coordinates of a destination address, a route may be determined by the direction creator module 412. Depending upon the type of display, a visual, audio, or combination of the two may be provided to a user with the directions. Common directions creator modules are well known in the art and are not explained in greater detail herein.

SMS input module 414 may allow for SMS messages to be input for communication by the telecommunication device, by using the GPS device input capabilities. As described previously, the input methods available to the GPS device, such as text entry or audio entry, may allow a user to enter SMS messages through the GPS device without having to get the users telecommunications device out of their pocket. In an exemplary embodiment, a user may speak a command initiating the SMS input module and then dictate a message through the GPS device, all without ever taking their eyes off the road. A speech-to-text conversion module, as is commonly known in the art, may be provided to convert the spoken message into an SMS format message. Audio input notwithstanding, the ability to use the keyboard or other manual input into the GPS device may also be available.

FIG. 5 is a block diagram of an exemplary process 500 for communicating message data from a telecommunications device to a GPS device. In step 502, a communications link is established between a telecommunications device and a GPS device. Any type of communications link may be used, including Bluetooth®, USB, radio, or any other type of wired or wireless connection. A telecommunications device may be any type of cellular telephone, PDA, text messaging device, or any other device capable of communicating message data to the GPS device. As mentioned previously, the GPS device may be built-in to a vehicle or may be portable. In step 504, message data is received from the telecommunications device by the GPS device via the communications link. Depending upon the protocol used for the communications link, various components and processes for receiving message data may be used. The message data may be in audio format (e.g., a voicemail message) or may be in text format (e.g., SMS or e-mail messages). Some formatting of the message data may be performed, such as in the case of audio format data being converted into a text based format for processing.

In step 506, the message data is displayed by the GPS device. Part or all of the message data may be provided in list form on an electronic display, thereby allowing a user the ability to select a message for further viewing and processing. In an alternative embodiment, the message data may be converted to audio to be provided to a user, where a user may hear the message data rather than view the message data. In step 508, GPS input is selected from the displayed message data. As described previously, message data that includes relevant address information for the GPS may be automatically associated with the GPS input. For missing or incorrect fields, the user may be able to correct the input to provide an accurate address. By allowing GPS input to be selected from the displayed message data, some, if not all, of the address may be provided to the GPS device with little or no manual user input, thereby making the address entry more efficient and potentially safer. Based on the selected GPS input, directions are calculated in step 510. Once the correct destination is found, using the current coordinates and the coordinates stored for the destination, directions for a route to the destination may be determined.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for communicating data from a telecommunications device to a Global Positioning System (GPS) device, said method comprising:
establishing a communications link between a telecommunications device and a GPS device;
receiving message data from the telecommunications device by the GPS device via the communications link;
displaying the message data by the GPS device;
selecting GPS input data from the displayed message data; and
calculating directions based on the selected GPS input data.

2. The method according to claim 1, wherein establishing the communications link includes pairing the telecommunications device with the GPS device using Bluetooth communications protocol.

3. The method according to claim 1, wherein receiving the message data includes receiving an SMS message.

4. The method according to claim 1, wherein receiving the message data includes receiving audio message data in audio format.

5. The method according to claim 1, further comprising converting audio message data into text for viewing on the GPS device.

6. The method according to claim 1, further comprising automatically analyzing the message to determine potential GPS input data.

7. The method according to claim 1, wherein selecting potential GPS input data includes selecting GPS input data in response to a touch screen located on the GPS device being utilized by a user.

8. The method according to claim 7, further comprising displaying selectable data elements to which displayed message data can be associated.

9. The method according to claim 1, wherein selecting GPS input data includes selecting GPS input in response to receiving voice commands.

10. The method according to claim 1, wherein selecting GPS input data includes selecting one of address information and landmark name.

11. A GPS device, comprising:
an input/output (I/O) unit;
a memory; and
a processing unit in communication with said I/O unit and said processing unit, said processing unit configured to:
establish a communications link via said I/O unit with a telecommunications device;
receive message data from the telecommunications device via the communications link;
display the message data;
accept selection of GPS input data from the displayed message data;
store the selected GPS input data in said memory; and
calculate directions based on the selected GPS input.

12. The GPS device according to claim 11, wherein said processing unit, in establishing the communications link, pairs with the telecommunications device using Bluetooth communications protocol.

13. The GPS device according to claim 11, wherein said I/O unit, in receiving the message data, receives an SMS message.

14. The GPS device according to claim 11, wherein said I/O unit, in receiving the message data, receives audio message data in audio format.

15. The GPS device according to claim 11, wherein said processing unit is further configured to convert audio message data into text message data for viewing on the GPS device.

16. The GPS device according to claim 11, wherein said processing unit is further configured to automatically analyze the message to determine potentially relevant GPS input.

17. The GPS device according to claim 11, further comprising a touch screen, and wherein said processing unit, in accepting selection of relevant GPS input, accepts GPS input data via said touch screen.

18. The GPS device according to claim 17, wherein said processing unit is further configured to display selectable data elements to which displayed message data can be associated.

19. The GPS device according to claim 11, wherein said processing unit, in accepting selection of GPS input data, accepts selection of GPS input data using voice commands.

20. The GPS device according to claim 11, wherein said processing unit, in accepting selection of GPS input, accepts selection of one of address information and landmark name.
